(19) United States
(12) Patent Application Publication
(10) Pub. No.: US 2002/0194143 A1
(43) Pub. Date: Dec. 19, 2002

(54) Method and system for usage-based pricing of E-content

(75) Inventors: Dwip N. Banerjee, Austin, TX (US); Rabindranath Dutta, Austin, TX (US)

Correspondence Address: STREETS & STEELE, 13831 NORTHWEST FREEWAY, SUITE 355, HOUSTON, TX, 77040, US

(73) Assignee: INTERNATIONAL BUSINESS MACHINES CORPORATION, ARMONK, NY

(21) Appl. No.: 09/843,070

(22) Filed: Apr. 26, 2001

(51) Int. Cl. G06F 17/00

(52) U.S. Cl. 705/400

(57) ABSTRACT

A method, computer system and computer program product for pricing access to e-content. The method includes tracking one or more usage characteristics of an individual's access to e-content, wherein the one or more usage characteristics are selected from the group consisting of the quantity of e-content accessed, the quantity of time spent accessing the e-content, the nature of the e-content, and combinations thereof. The individual is charged a price that is determined as a predetermined function of the one or more usage characteristics. The method may further comprise establishing, storing and updating a usage profile for the individual. The method may also comprise transmitting the e-content from a server to a computer along with a usage tracker for performing the step of tracking one or more usage characteristics, and accepting return of the e-content from the computer along with the one or more usage characteristics.

### BACKGROUND OF THE INVENTION

1. Field of the Invention

The present invention relates to methods and systems for e-content distribution. In particular, the invention relates to methods and systems for e-content checkout, extension, return, and usage tracking.

2. Description of the Related Art

Online content that is accessible through the Internet, often referred to as “e-content”, can take many forms, including advertising, educational information, news, online catalogs, and the like. While online advertisers and marketers provide their content for free and earn revenue from sales, some types of e-content providers are in the business of providing e-content itself and must earn their revenue from the distribution of the e-content. The later type of e-content providers typically provides e-content services or products, such as e-books, e-videos, e-movies, e-television, e-games, e-software, e-documents, and the like.

One alternative to selling the “e-content” or “title” is known as “pay-per-view.” In a pay-per-view system, the user does not purchase a copy of the e-content, but rather purchases the right to access the e-content a single time. In this manner, the user is prevented from multiple uses or viewing of the e-content unless the user pays another access fee. The result is that consumers pay for access in proportion to the number of times the e-content is accessed.

One problem associated with pay-per-view systems is the inflexibility of the access and pricing structure, which is really no different than their brick-and-mortar equivalents, namely video rental stores, movie theatres, arcades, and the like. These pay-per-view type systems always provide the consumer with full access to the content, but similarly always charge the consumer for full access. While these systems are simple and acceptable to many consumers, these systems do not recognize that consumers may be interrupted after only partial access or viewing, that consumers may only be interested in a portion of the e-content, or that consumers may recognize quickly that they do not enjoy the e-content or asked for the wrong e-content.

Accordingly, there is a need for methods and systems that provide access to e-content in a more flexible manner based on the extent of access or usage, rather than the number of access sessions. There is also a need for methods and systems that track the extent of access or usage of e-content and charge the consumer in accordance with the extent of access. It would be desirable if the methods and systems allowed access to a greater variety of e-content types, such as software, that are not well suited to pay-per-view schemes. It would be further desirable if the methods and systems provided consumer incentives, such as free sampling of e-content, volume discounts, and the like.

### SUMMARY OF THE INVENTION

The present invention provides a method for pricing access to e-content. The method comprises tracking one or more usage characteristics of an individual's access to e-content, wherein the one or more usage characteristics are selected from the group consisting of the quantity of e-content accessed, the quantity of time spent accessing the e-content, the nature of the e-content, and combinations thereof. The individual is charged a price that is determined as a predetermined function of the one or more usage characteristics. Optionally, the method may further comprise establishing a usage profile for the individual, storing in the usage profile the one or more usage characteristics tracked during a first session, and updating the usage profile to reflect the one or more usage characteristics tracked during a subsequent session. The step of updating the usage profile may include accumulating the one or more usage characteristics over a plurality of sessions. Preferably, the price is determined as a predetermined function of the one or more usage characteristics of the current session, the one or more accumulated usage characteristics, or a combination thereof. The method may also comprise transmitting the e-content to a computer along with a usage tracker for performing the step of tracking one or more usage characteristics, and accepting return of the e-content from the computer along with the one or more usage characteristics. Examples of accepting return of the e-content include receiving the entire e-content, deleting the e-content from the individual's computer, or determining whether any copies of the transmitted e-content were made. In one embodiment, the e-content is transmitted from a server to a computer along with a usage tracker for performing the step of tracking one or more usage characteristics, then the usage tracker periodically sends messages to the server indicating a change in the one or more usage characteristics.

The invention also provides a method for managing access to e-content, comprising: downloading e-content from a server to a client computing device along with an embedded usage tracking program; monitoring, using the usage tracking program, one or more characteristic of the client's access to the e-content; transmitting, using the usage tracking program, a usage report including the one or more characteristics from the client to the server; determining whether the client's access to the e-content exceeds an expiration setpoint; and upon a determination of expiration, extending the expiration setpoint.

A computer system for pricing access to e-content is provided, wherein the system comprises tracking means for tracking one or more usage characteristics of an individual's access to e-content, wherein the one or more usage characteristics are selected from the group consisting of the quantity of e-content accessed, the quantity of time spent accessing the e-content, the nature of the e-content, and combinations thereof. The system also includes charging means for charging the individual a price that is determined as a predetermined function of the one or more usage characteristics. Optionally, the system may further comprise establishing means for establishing a usage profile for the individual, storing means for storing in the usage profile the one or more usage characteristics tracked during a first session, and updating means for updating the usage profile to reflect the one or more usage characteristics tracked during a subsequent session. In one embodiment, the system also comprises transmitting means for transmitting the e-content to a computer along with a usage tracker for tracking one or more usage characteristics, and accepting means for accepting return of the e-content from the computer along with the one or more usage characteristics. In another embodiment, the system will comprise transmitting means for transmitting the e-content to a computer along with a usage tracker having tracking means for tracking one or more usage characteristics, and receiving means for receiving messages from the usage tracker indicating a change in the one or more usage characteristics.

Finally, the invention provides a computer program product including instructions embodied on a computer readable medium, the instructions comprising tracking instructions for tracking one or more usage characteristics of an individual's access to e-content, wherein the one or more usage characteristics are selected from the group consisting of the quantity of e-content accessed, the quantity of time spent accessing the e-content, the nature of the e-content, and combinations thereof. The method also comprises charging instructions for charging the individual a price that is determined as a predetermined function of the one or more usage characteristics.

The foregoing and other objects, features and advantages of the invention will be apparent from the following more particular description of a preferred embodiment of the invention, as illustrated in the accompanying drawing wherein like reference numbers represent like parts of the invention.

### BRIEF DESCRIPTION OF THE DRAWINGS

FIG. 1 is a structural diagram of a distributed data processing system illustrating the relationship of an e-content server with consumers or clients.

FIG. 2 illustrates a client system communicating with a server system to access e-content located on the e-content server according to the present invention.

FIG. 3 is an example of a client computer system in which the present invention may be implemented.

FIG. 4 is a block diagram of one embodiment of a usage management system in accordance with the present invention.

FIG. 5 illustrates the process for monitoring subscriber related activities that lead to the generation of usage event records.

FIG. 6 illustrates an embodiment of an online teleprocessing gateway, in accordance with the invention, having various TCP client and server sockets.

FIG. 7 is a flowchart illustrating the operation of the online teleprocessing gateway illustrated in FIG. 6.

FIG. 8 is a flowchart of a dynamic, usage-based pricing process that would be executed by the service and billing server of FIG. 6.

FIG. 9 is a flowchart of an e-content checkout extension process of the present invention.

### DETAILED DESCRIPTION

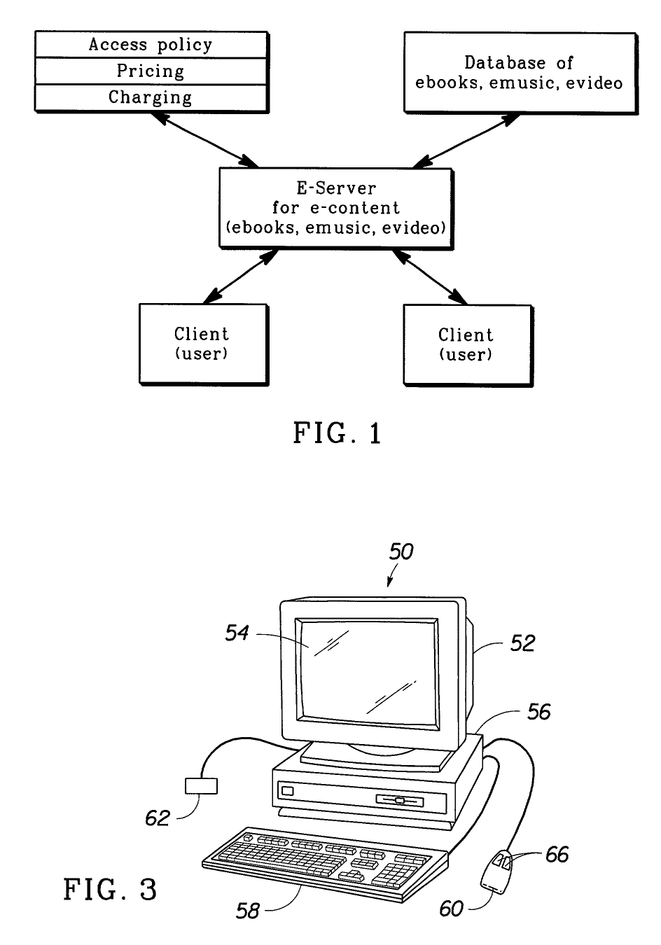

FIG. 1 is a structural diagram of a distributed data processing system 10 illustrating the relationship of an e-content server 11 with multiple e-content clients or consumers 12 for communication over a communications system or network 13, such as the Internet, an intranet or other network system. As illustrated, the user at the client workstation 12 can obtain access over the computer network 13 to an e-content record 15 located in a database 14 on the server 11 through the user's web browser 17. The e-content server 11 of the present invention may be a Web Application Server (WAS), a server application, or a servlet process, where the server includes e-content access policies 16 and an e-content accounting database 18 containing instructions for handling e-content. The e-content server 11 is also in communication with a database of titles for a variety of e-content applications, such as e-books, e-music and e-video. The web server 11 preferably generates a graphical user interface that is displayed by the browser 17 providing the individual options to the client. A preferred e-content client system 12 is shown in more detail in FIG. 3.

Optionally, client 12 submits the required user information to identify themselves as being authorized to access the requested information. User information can include data such as a password or a combination of a user identification and password assigned by the server 11.

Network 13 is the medium used to provide communications links between various devices and computers connected together within distributed data processing system 10. Network 13 may include permanent connections, such as wire or fiber optic cables, or temporary connections made through telephone or wireless communications. Clients and servers may be represented by a variety of computing devices, such as mainframes, personal computers, personal digital assistants (PDAs), smart phones, etc. Distributed data processing system may include additional servers, clients, routers and other devices not shown. In the depicted example, the distributed data processing system 10 may include the Internet with network 13 representing a worldwide collection of networks and gateways that use the TCP/IP suite of protocols to communicate with one another. Of course, the distributed data processing system may also include a number of different types of networks, such as, for example, an intranet, a local area network (LAN), or a wide area network (WAN).

The present invention could be implemented on a variety of hardware platforms and could be implemented in a variety of software environments. A typical operating system may be used to control program execution within the data processing system. Furthermore, although the preferred embodiment described below includes a “browser” at the client as the agent which exchanges data in the security protocols with the Web Application Server, the agent at the client does not have to be a conventional browser, e.g., Netscape Navigator® or Microsoft Internet Explorer®. In order to secure the information transmitted to and from the server, the client may be capable of Public Key Infrastructure (PKI) technology exchanged in a security protocol such as the Secure Sockets Layer (SSL) version 3.0 and above.

Web application server 11 includes a conventional server software program such as International Business Machines' Websphere®, for administering operation of the e-content server. The server software includes application programs that enable the server 11 to manage the e-content database, execute e-content access policies 16, and maintain the accounting database 18.

It should be recognized that the present invention may be implemented over communication systems that include fiber optics, wire or wireless technology, such as Wireless Application Protocol (“WAP”) or Bluetooth based communication mechanisms, or combinations thereof.

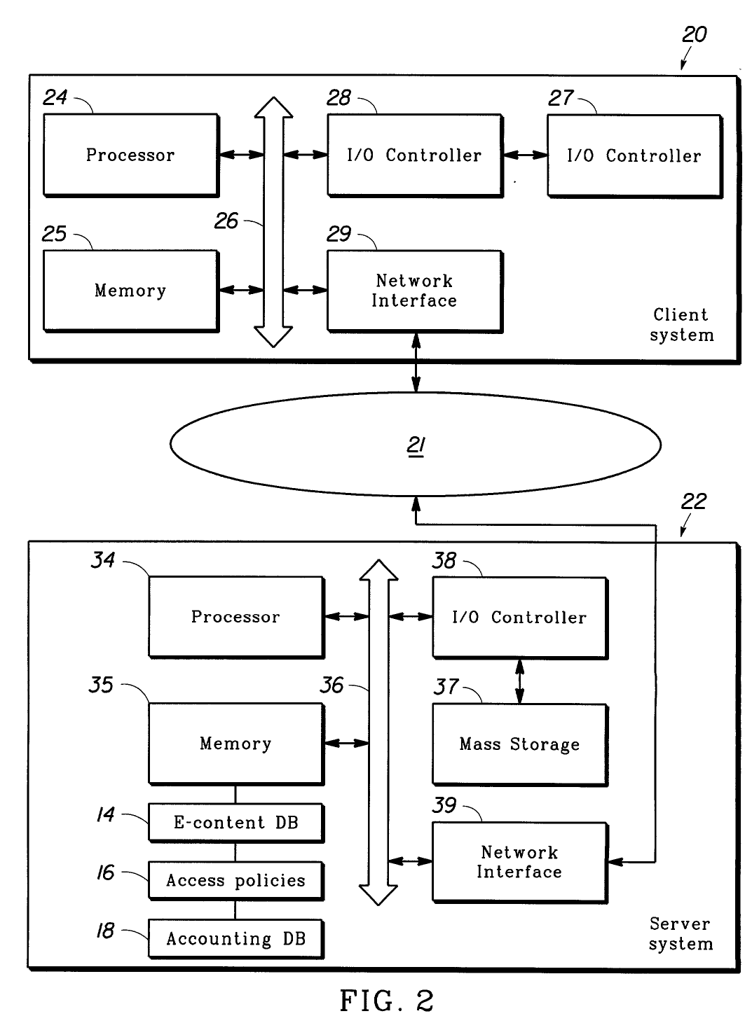

FIG. 2 depicts an example of a client-server system connected through the Internet 21. In this example, a remote server system 22 is connected through the Internet to client system 20. The client system 20 includes conventional components such as a processor 24, memory 25 (e.g. RAM), a bus 26 which couples the processor 24 and memory 25, a mass storage device 27 (e.g. a magnetic hard disk or an optical storage disk) coupled to the processor and memory through an I/O controller 28 and a network interface 29, such as a conventional modem. The server system 22 also includes conventional components such as a processor 34, memory 35 (e.g. RAM), a bus 36 which couples the processor 34 and memory 35, a mass storage device 37 (e.g. a magnetic or optical disk) coupled to the processor 34 and memory 35 through an I/O controller 38 and a network interface 39, such as a conventional modem. It will be appreciated from the description below that the present invention may be implemented in software that is stored as executable instructions on a computer readable medium on the client and server systems, such as mass storage devices 27 and 37 respectively, or in memories 25 and 35 respectively. The server system 22 is shown having the e-content database 14, access polices 16, and accounting database 18 stored in memory 35. The server 22 is thus suitable for processing: (1) e-content access, (2) e-content transmission or checkout, (3) usage tracking, and (4) dynamic, usage-based pricing for accessing the e-content. The server 22 also preferably includes electronic mail software for processing e-mail messages and storing e-mail messages transmitted between the server and the various clients.

The server and systems shown in FIGS. 1 and 2 are suitable for distribution of e-content as well as dynamic accounting for usage of the e-content. A suitable usage management system is disclosed in U.S. Pat. No. 5,778,182 which is incorporated by reference herein. The methods and systems of the present invention for dynamic pricing of e-content and checkout extension will be discussed in more detail below.

FIG. 3 shows a client computer system 50 that can run a browser. The computer system 50 includes a display device 52 (such as a monitor), a display screen 54, a cabinet 56 (which encloses components typically found in a computer, such as CPU, RAM, ROM, video card, hard drive, sound card, serial ports, etc.), a keyboard 58, a mouse 60 and a modem or 62. Mouse 60 may have one or more buttons or control devices, such as buttons 66. The computer requires some type of communication device such as modem 62 that allows computer system 50 to be connected to the Internet. Other possible communication devices include ethernet network cards.

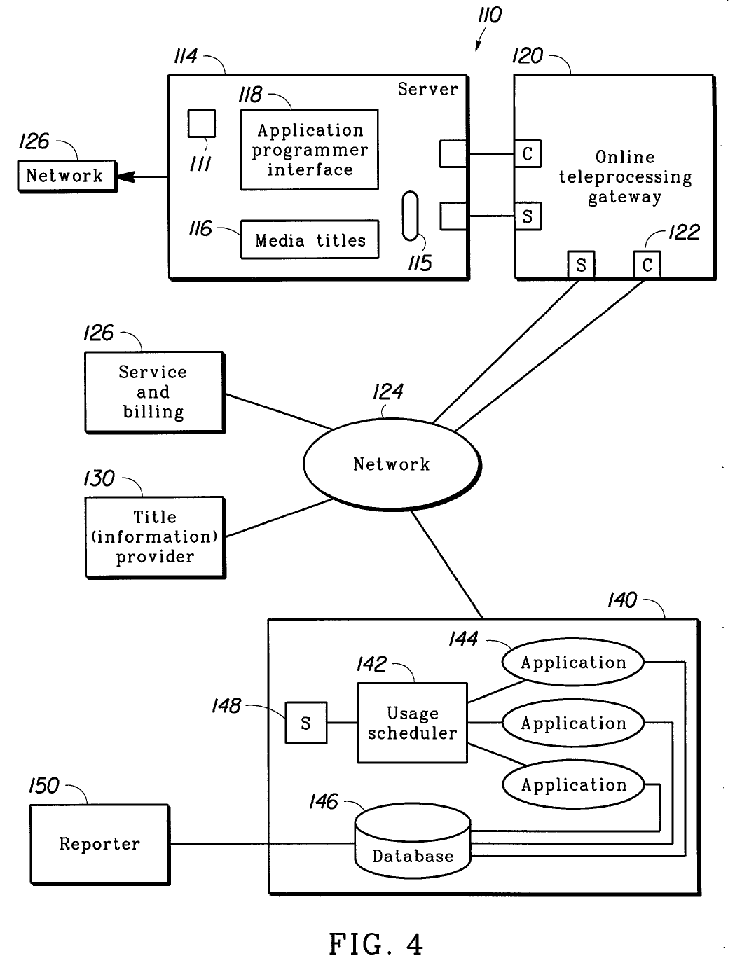

FIG. 4 is a block diagram of one embodiment of a usage management system 110 in accordance with the present invention. Usage management system 110 includes an e-content server 114. Optionally, the interactive server 114 comprises a server complex, wherein several servers interact to provide interactive services to subscribers/clients/users. Interactive server 114 includes a control server 111, which supervises the activities of server 114, and interfaces with usage management system 140 as will be explained in more detail hereinafter. Another server included in interactive television server 114 is a title or media server 116 that is configured to transmit desired applications or titles in response to demands made by the subscribers. Title server 116 functions as a communication manager and operates in conjunction with a database server 115, such as a Sybase database server. In response to a subscriber's demand, title or media server 116 retrieves from database management server 115, a copy of the title or application demanded by the subscriber. Title or media server 116 then executes the retrieved copy of the demanded title or application and transmits the outcome to the subscriber's computer.

Interactive server 114 also includes an application programmer's interface 118 that generates records that contain information about specific actions or events that the usage management system 110 intends to track and store. In the present context, each event represents a group of predefined actions that are generated by a title, in response to a demand made by a subscriber. Events are predefined by the title developers and users of the management system 110. Each of these events may include a plurality of domains that are being executed concurrently. Each domain defines at least one logical location in a title or an application whose contents may be provided to a subscriber. A logical location in a title may be the source of certain information or data being provided to a subscriber at a specific time. For example, this source of information may be a memory device or a file containing data related to items offered for sale in an interactive shopping session with a consumer. Another source of information may be the data corresponding to a prerecorded movie furnished by a title provider. The information model for tracking subscriber usage according to one embodiment of invention is based on usage of these logical locations or domains within a title. Thus each event record generated by the application programmer's interface contains information relating to one or more of these domains or logical locations. For example, when a subscriber accesses a desired title, the system generates an event record that contains domain data representing that title. This domain data is referred to as the title domain for the selected title. When the consumer accesses another location within that title, the system generates another event record that contains domain data indicating the usage of this other location. The usage management system 110, tracks the usage of each domain within consecutive event records.

The records generated by the application programmer's interface 118 have a predefined format. Application programmer's interface 118 allows the title providers to develop their titles, without knowing the exact format of event records that each title needs to generate. Application programmer's interface 118 generates records based on a standardized format, relieving the application or title software from the task of formatting these records. However, it can be appreciated that the title providers may develop applications that can generate event records according to a predefined format, and therefore, the invention is not limited in scope to a system including an application programmer's interface.

The output signals generated by interactive server 114 are coupled to an on-line teleprocessing gateway 120, which functions as a gateway, for interactive television transactions, to entities external to interactive server 114. These transactions may be any application level data set or record that is to be transmitted from or received by the interactive server 114. The on-line teleprocessing gateway 120 uses common industry communication standards to ensure data integrity. For example, in one embodiment of the invention, as illustrated in FIG. 4, gateway 120 employs a communication protocol known as transmission control protocol/internet protocol (TCP/IP) via TCP/IP standard sockets to send and receive information to the outside world. Gateway 120 communicates with interactive server 114 via an Ethernet network.

On-line teleprocessing gateway 120 uses a TCP client socket 122 to transmit information to a usage processing system 140 via a communication network 124. Communication network 124 provides access to the system by other remotely located administration servers. For example, subscriber service and billing server 126 is coupled to on-line teleprocessing gateway 120 to process a variety of administrative services. These services include channel mapping commands, intended for use by interactive television server 114, so as to provide the allocation of available channels to the subscribers. Other services include billing verification and subscription termination commands, when service to a subscriber terminates.

Usage processing system 140 uses a TCP server socket 148 to receive the usage event records from on-line teleprocessing gateway 120. The usage processing system includes a usage scheduler 142 to transport usage event records from TCP server 148 to usage application servers 144. In one embodiment of the invention, a plurality of usage application servers 144 run at the same time to accommodate the incoming usage event records.

Usage application servers 144 interface with usage scheduler 142 to receive the usage event records generated by interactive server 114 via online teleprocessing gateway 120. Each usage application server 144 calculates the aggregate time of various interactive television usage domains spanning over a consecutive sequence of event records. Usage processing system 140 then records, in the usage processing database storage 146, each occurrence of a usage domain and the corresponding time period that the usage domain remained active. As mentioned earlier, usage domain is defined by each title as a specific logical area within the title for which title providers or e-content providers want to track usage. A domain may be a specific title, segment, activity or frame. Domains may also be defined to include groups of titles, such as shopping, or the whole interactive session.

Usage processing system 140 also includes a usage reporter that analyzes the data stored in database storage 146 and generates various usage reports. The report formats support the overall requirement for tracking subscriber usage and subscriber's navigational paths across the various titles. For example, certain reports depict usage by the number of times a particular title is accessed. Based on the usage occurrences and subscriber navigation information, title providers can track subscribers' usage behavior over a period of time. The operation of each one of the components of the usage management system 110 is described in more detail hereinafter.

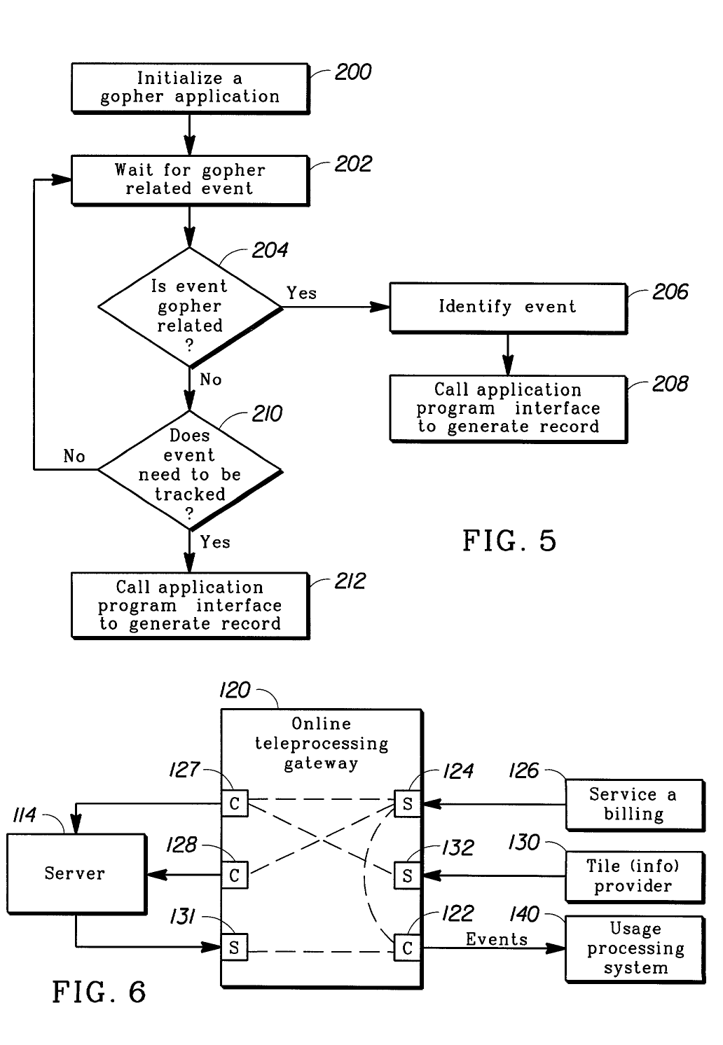

FIG. 5 illustrates the process for monitoring subscriber related activities that lead to the generation of usage event records. The e-content server 14, includes two types of applications known as the gopher application and all other title applications. The gopher application, which is a supervisor process to all title applications, is aware when viewers are accessing e-content, for example by turning “on” and “off” a dedicated purpose device such as a television set top box or attempting to logon from a multipurpose computing device such as a personal computer. All usage events related to these activities are processed by the gopher application. All other usage related events are processed by the title applications.

As illustrated in FIG. 5, e-content server 114 initializes the gopher application at step 200. The system at step 202 waits for a signal from client device 20 of FIG. 2, indicating an activity intended to be processed by the gopher application. At step 204, if the gopher application receives such a signal, the system identifies the corresponding event at step 206. Thereafter, the system goes to step 208 to call the application programmer's interface to generate an event record corresponding to the identified event. In the alternative, if at step 204, gopher application receives a signal not related to a gopher activity, the system goes to step 210 to determine whether the signal received from the client device corresponds to a title event that needs to be tracked. If not, the system goes back to step 202 and monitors the signals generated by the client device 20 of FIG. 2.

If, however, an event to be tracked is identified at step 212, the title application calls the application programmer's interface to generate an event record corresponding to the identified event. The title application sends function calls to the application programmer's interface to populate an event record with the data corresponding to logical locations or domains within the title that are being used by a particular subscriber.

Each event record according to one embodiment of the invention contains three data portions. The first portion is referred to as the Standard Record Elements. The second portion contains the event specific domains. The third portion contains the event specific data.

The Standard Record Elements portion contains all the housekeeping information about the subscriber and the time the event has been generated. More specifically the Standard Record Elements portion contains the following data elements:

1. AccountNo.: This element identifies the subscriber's account, which serves as a billing reference for a group of people at the same address;

2. OutletNo.: This element identifies an installation of a cable or set top box within a household. There may be several set top boxes within a household, each being used by a different user;

3. Dttm: This element refers to the date and the time when a specific event took place.

4. TitleDomain: This element refers to the specific title or application from which an event record is being generated.

5. NumberOfUsageDomains: This element refers to the number of usage domains that are present within the event record.

6. ConsumerId: This element is a unique identifier for a user of the set top box. This allows the system to track a plurality of users within the same household.

7. EventType: This element refers to the classification of actions or occurrences that take place while a consumer is utilizing a set top box.

8. PlaceId: This element is a unique identifier for a place within a domain. A place is a logical area or a location in an interactive television title or application at a specific instant of time. This element is used to track the navigation of a consumer during a television session.

9. EntryMethod: This element is a code, which describes the method a subscriber chose to enter a logical place. For example “0” means that the consumer changed channel by entering channel number on the remote control. “1” means that the subscriber chose a menu option with a control mouse device coupled to the set top box. “2” means that the subscriber chose menu option with a remote keypad.

When application programmer's interface 118 receives a function call from a title or application, it populates an event record with the corresponding data elements in order to generate an event record. In addition, application programmer's interface 118 populates the event record with standard record elements (SRE) described above. Each event record contains information for those domains used by a subscriber.

TABLE 1

Sign-On Event
Data Element Function Call
Domain ID AddDomain()
Title Domain ID SetTitleDomain()
Consumer ID SetConsumerId()
Place ID SetPlaceId()
Entry Method Code SetEntryMethodCd()

For a Sign-On event, the AddDomain( ) function in Table 1 is executed by the gopher application. This function allows the addition of one or more domains that are desired to be tracked. The SetTitleDomain( ) sets the domain id representing the title or channel the subscriber is currently tuned. Typically, this function is part of a start up routine of a title. The SetConsumerId( ) function is used to identify a subscriber. This function begins at the start of a title or at any time subscribers choose to identify themselves. The SetPlaceId( ) function sets the specific title-defined place that a Subscriber is currently located within a domain. This function is used to track navigation within a title or between channels. Finally, the SetEntryMethodCd( ) function sets the entry method used by the subscriber as mentioned before. This function is used to track navigational related data.

Table 2 illustrates the data elements and function calls related to the Sign Off Event. This event is recorded when a subscriber powers off the computing device. In one embodiment of the invention the Sign Off Event uses the same function calls as the Sign On Event.

TABLE 2

Sign Off Event
Date Element Function Call
Domain ID AddDomain()
Title Domain ID SetTitleDomain()
Consumer ID SetConsumerId()
Place ID SetPlaceId()
Entry Method Code SetEntryMethodCd()

Therefore, once the subscriber signs off the system, the gopher application receives a signal indicating that a subscriber is signing off. It then generates the Sign Off Event record by executing the functions illustrated in table 2.

Table 3 illustrates the data elements and the corresponding function calls for generating a Usage Event record. The Usage Event record contains information relating to subscriber's usage of a particular domain in a title.

TABLE 3

Usage Event
Data Element Function Call
Domain ID AddDomain()
Title Domain ID SetTitleDomain()
Consumer ID SetConsumerId()
Place ID SetPlaceId()
Entry Method Code SetEntryMethodCd()

The usage event record tracks one or more domains within a title that need to be tracked. For example, one usage domain may be defined as a menu page of a home shopping title. Another usage domain may be one of the categories available from the menu page of the home shopping title. A further usage domain may be a list of discounted items within that category. As a result, a first usage event may be defined by the menu page domain. A second usage event may be defined by a combination of menu page and category domains. Yet a third usage event may be defined by a combination of category domain and list of discounted items domain. It is thus possible in accordance with one embodiment of the invention, to track usage events based on monitored domains. Conversely, it is also possible in accordance with another embodiment of the invention to track an active domain that may be present in a plurality of consecutive events. For the example of usage events mentioned above, the category domain remains active in the second and third usage events. Thus, it is possible to track the duration of an active domain that spans consecutive events.

Table 4 illustrates the data elements and function calls relating to the Consumer Identification Event. This event is recorded when a subscriber needs to be identified. The data elements and function calls to generate this event is the same as those illustrated in tables 1-3.

TABLE 4

Consumer Identification Event
Data Element Function Call
Usage Domain AddDomain()
Title Domain SetTitleDomain()
Consumer ID SetConsumerId()
PlaceID SetPlaceId()
Entry Method Code SetEntryMethodCd()

According to one embodiment of the invention, the system generates other event records. For example, the system generates a View Feature Event record that relates to certain situations where a consumer invokes a special effect or function while viewing a video clip. Such special effects or functions may include fast forwarding, rewinding or pausing the video clip. For a View Feature Event (not shown), the system generates event specific data elements in addition to those illustrated in tables 1-4. These data elements are “View Id” and “Feature.” The ViewId element identifies the function or special effects that are utilized by the subscribers while viewing a video clip. For example, the value FF refers to fast forward; RR refers to rewind; PA refers to pause; FS refers to a full screen; PS refers to a partial screen; VA refers to the viewing angle. The Feature element identifies the domain that relates to a specific promotion, movie or product-related video clip the subscriber is viewing.

Another event record that the system generates is New Or Change Order Event. This record relates to a situation where a subscriber places an order or modifies an order for a product or service. Table 5 illustrates the data elements and function calls corresponding to this event record.

TABLE 5

New Or Change Order Event
Data Element Function Call
Usage Domain AddDomain()
Title Domain SetTitleDomain()
Consumer ID SetConsumerId()
Place ID SetPlaceId()
Entry Method Code SetEntryMethodCode()
Payment Method
Number of Items Ordered
Total Tax Amount
Total Amount
Number of Points Gained/Used
Name of Person Shipped To
Information Provider ID
AddProduct()
Product Number
Quantity
Price

The AddProduct( ) function is used whenever a product or service has been purchased. This function allows many products to be recorded within a single transaction.

As mentioned earlier, the data elements that are generated by a function call fill up the event specific data portion of the event records. By using the function calls stated above as one example of the present invention, application programming interface 118 generates event records that contain information relating to the domains used by each subscriber in the system. When an event record is generated, application programming interface 118 sends the event record to the online teleprocessing gateway 120.

FIG. 6 illustrates an embodiment of an online teleprocessing gateway 20, in accordance with the invention, having various TCP client and server sockets. The online teleprocessing gateway 20 acts as an interactive transaction gateway. Each transaction is defined as any application level data set or record that needs to be transmitted between external entities and the server 114. These external entities may include a usage processing system 140, customer service and billing processor 126 and information providers 130. Sockets 124, 131, and 132 of the online teleprocessing gateway 120 are TCP Server sockets. Sockets 122, 127 and 128 are TCP Client sockets. Customer service and billing server 126 sends administrative data to socket 124 of online teleprocessing gateway 120. This information in turn is reformatted and prepared for transmission to server 114. Furthermore, socket 131 receives event records from server 114 and prepares the record for transmission to usage processing system 140 via TCP client socket 122.

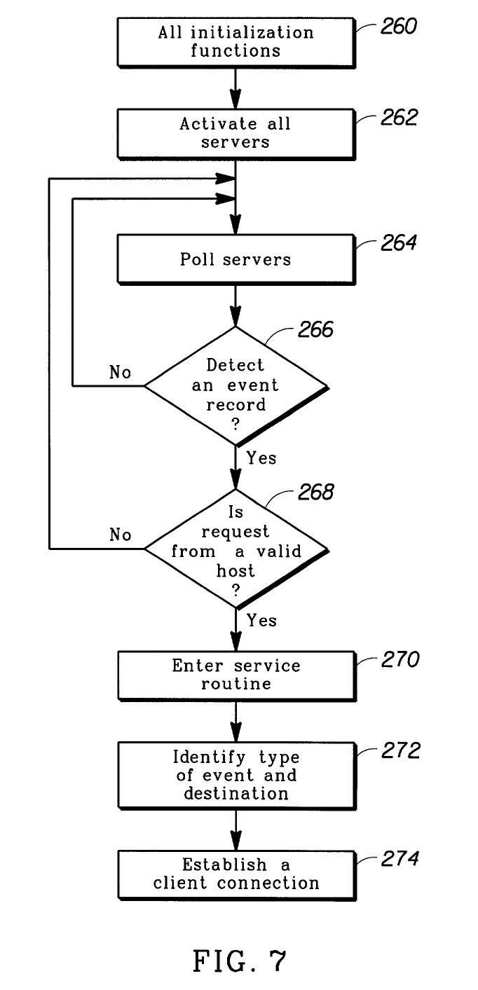

FIG. 7 is a flowchart illustrating the operation of online teleprocessing gateway 120. At step 260, the system enters initialization mode by calling initialization functions. The initialization functions are responsible for reading all the configuration files stored in connection with the operation of gateway 120. These initialization functions also initialize all the tables stored in gateway 120. At step 262, the system sets up multiple listening ports or sockets based on the number of external entities that intend to communicate with online teleprocessing gateway 120. Typically there are one or two ports or sockets per entity. Each port is driven by a separate application server within the gateway 120.

Gateway 120 functions as what is known in the art as a “server daemon.” Server Daemons are well known in the art and defined in Unix Network Programming by W. Richard Stevens (Prentice Hall, 1990). Basically, a daemon is a process that executes in the background either waiting for some event to occur, or waiting to perform some specified task on a periodic basis. Typically, in one embodiment of the invention, a daemon may be a UNIX process, which controls application-level data communications for a multi-media server such as media server 116. The scope of the daemon extends to clients who can get connection to one of the mentioned servers and could have their transaction routed to a specific destination. Online teleprocessing gateway 120 includes a dedicated management information base (MIB) that contains communications information on each entity coupled to online teleprocessing gateway 120. A plurality of monitoring processes or hooks known as simple network management protocol (SNMP) use information contained in MIB to monitor the communication status of each connected entity. SNMP hooks are installed in a single entity. It can be appreciated that multiple servers can also be used. This approach will lead to multiple MIBs and SNMP hooks in each server.

As mentioned, gateway 120 directs every transaction that it receives to a predetermined location. Therefore, at step 262, gateway 120 also establishes client connections to the destination server. These client connections are typically raw socket based TCP/IP clients. Gateway 120 also sets up a Sybase open-client connection to e-content server 114 via TCP client server socket 128, for sending, information that updates Sybase database 115 in server 114.

At step 264 the system enters a continuous loop waiting for the occurrence of events. Gateway 120 polls all the TCP server sockets or ports. At step 266, gateway 120 determines whether an event has been sent by an outside entity. If so, at step 268 the system determines whether the information received from the outside entity is valid. This is to make sure that only authorized users are allowed access into gateway 120. At step 270 the system enters a service routine. It also goes back to step 264 to poll sockets for incoming signals. Meanwhile, the server assigned to the port or socket that has received an event record begins execution. At step 272 each server that is prompted to act, identifies the type of event and the destination of the record. Thereafter the servers establish a client connection with the intended destination at step 274.

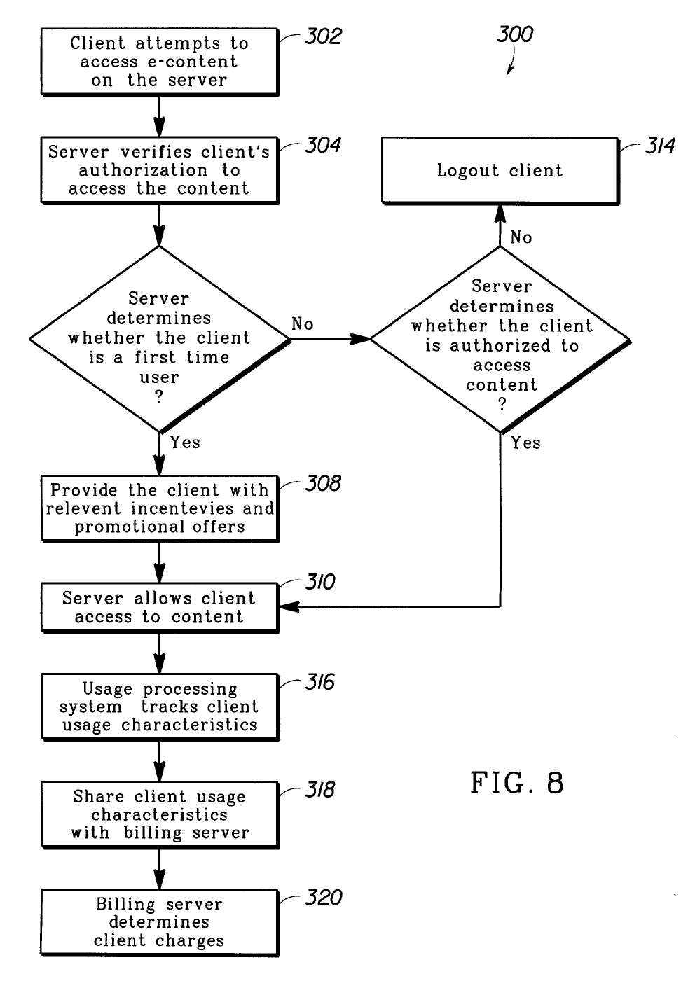

FIG. 8 is a flowchart of a dynamic, usage-based pricing process 300 that would be executed by the service and billing server 126 of FIG. 6. In state 302, the client 20 attempts to access e-content through the server 114. The server 114 then verifies, in state 304, that the client 20 is authorized to access the e-content in accordance with the server access policies 16. In state 306, the server 114 determines whether the client 20 attempting access is a first-time user, for example by determining whether the user already has an account. If the user is determined to be a first-time user, then any relevant incentives or offers are provided to the user in state 308, followed by the client 20 being allowed access to the e-content in state 310.

If the server determines, in state 306, that the user 20 is not a first-time user, such as by locating an existing account for the client, then the server 114 determines whether the client is authorized to access the e-content in state 312. For example, authorization for the client to access the e-content may depend upon the client's account payment status, remaining promotional privileges, account restrictions, or client obedience of usage restrictions. If the client 20 is not authorized, then the client is logged-out in state 314. Conversely, if the client is determined to be authorized, then the server 114 allows the client to access the e-content in state 310.

Following state 310, the usage processing system 140 tracks one or more client usage characteristics in state 316, preferably in accordance with the event records generated by the application programmer interface 118 of FIG. 4. The one or more client usage characteristics tracked in state 316 are then shared with the billing server 126 in state 318. The billing server 126 then determines the appropriate client charges on the basis of the usage characteristics, in state 320.

The determination of charges may involve any algorithm or rate schedule so long as the usage is one factor in the calculation. More particularly, the method may include charging the individual a price that is determined as a predetermined function of the one or more usage characteristics. Preferably, the usage is the primary or only variable in the determination of charges. For example, the algorithm may be a linear, exponential, or other mathematical expression that is a function of client usage and produces a result that represents an amount of currency to be charged. Most preferably, the algorithm will be selected to encourage various aspects of usage, such as volume, frequency and type of e-content accessed, by providing reduced marginal charges for accessing the promoted e-content. It is even anticipated that the client may receive rebates or credit for accessing e-content in the nature of advertising, informational commercials or shopping. The usage characteristics that are tracked may be any measurable characteristic, such as the number of titles accessed, time spent accessing or using the e-content, type or nature of e-content accessed, number of domains accessed or the amount of server processing or uploading time consumed.

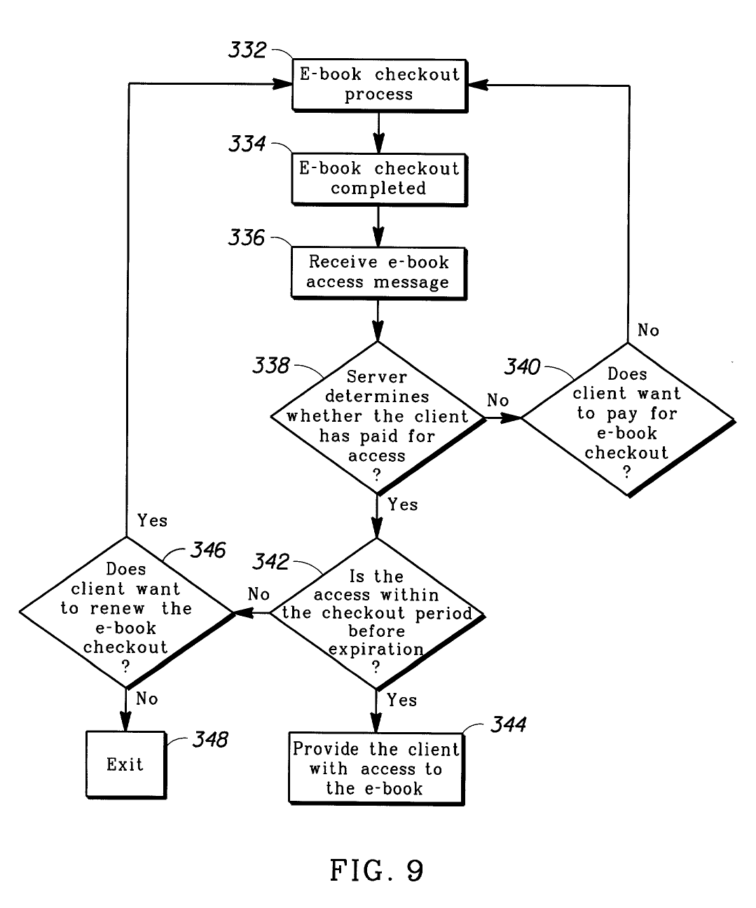

FIG. 9 is a flowchart of an e-content checkout extension process 330 of the present invention. While the process is described as if executed by a usage tracker downloaded to the client computer along with the e-content, the process may just as easily be executed by a component of the e-content server where the e-content is viewable by the client but maintained on the server. Accordingly, a client 20 checks out, rents or otherwise accesses an e-content title available on the server 114 in state 332, such checkout process presumably including a fee being charged to the client whether this is an original checkout or a renewal. After completing the e-content checkout or download to the client 20 in state 334, state 336 provides that the usage tracker instructions that are downloaded along with the e-content will transmit usage messages or reports from the client 20 to the server 114 regarding one or more characteristic of the client's accessing of the e-content.

After the server has receiving a usage report in step 336, the server 114 determines, in state 338, whether the client 20 has paid for the access. If the client has not paid for access, then control is passed to state 340 where the server queries whether the client wants to pay for access to the e-content. If the client does want to pay for access, then control is passed to state 332 for checkout. However, if it is determined in state 338 that the client has in fact paid for access, then the server determines in state 342 whether the client is attempting to access the e-content within the checkout period before expiration. If the client has paid, then state 344 provides the client with access to the e-content. Conversely, if the client has previously paid for access as determined in state 338, but the access period has expired as determined in state 342, then the server queries whether the client wants to renew the e-content checkout in state 346. If the client wants to renew, then control is passed back to state 332, else the process exits in state 348.

It will be understood from the foregoing description that various modifications and changes may be made in the preferred embodiment of the present invention without departing from its true spirit. It is intended that this description is for purposes of illustration only and should not be construed in a limiting sense. The scope of this invention should be limited only by the language of the following claims.

What is claimed is:

1. A method for pricing access to e-content comprising:
tracking one or more usage characteristics of an individual's access to e-content, wherein the one or more usage characteristics are selected from the group consisting of quantity of e-content accessed, quantity of time spent accessing the e-content, nature of the e-content, and combinations thereof; and
charging the individual a price that is determined as a predetermined function of the one or more usage characteristics.

2. The method of claim 1, further comprising:
establishing a usage profile for the individual;
storing in the usage profile the one or more usage characteristics tracked during a first session; and
updating the usage profile to reflect the one or more usage characteristics tracked during a subsequent session.

3. The method of claim 2, wherein the step of updating the usage profile includes accumulating the one or more usage characteristics over a plurality of sessions.

4. The method of claim 3, wherein the price is determined as a predetermined function of the one or more usage characteristics of the current session, the one or more accumulated usage characteristics, or a combination thereof.

5. The method of claim 1, wherein the predetermined function is a non-linear function.

6. The method of claim 1, further comprising:
transmitting the e-content to a computer along with a usage tracker for performing the step of tracking one or more usage characteristics; and
accepting return of the e-content from the computer along with the one or more usage characteristics.

7. The method of claim 6, wherein the step of accepting return includes receiving the entire e-content.

8. The method of claim 6, wherein the step of accepting return includes deleting the e-content from the individual's computer.

9. The method of claim 6, wherein the step of accepting return includes determining whether any copies of the transmitted e-content were made.

10. The method of claim 1, further comprising:
transmitting the e-content to a computer along with a usage tracker for performing the step of tracking one or more usage characteristics; and
periodically receiving messages from the usage tracker indicating a change in the one or more usage characteristics.

11. A method for managing access to e-content, comprising:
downloading e-content from a server to a client computing device along with an embedded usage tracking program;
monitoring, using the usage tracking program, one or more characteristic of the client's access to the e-content;
transmitting, using the usage tracking program, a usage report including the one or more characteristics from the client to the server;
determining whether the client's access to the e-content exceeds an expiration setpoint; and
upon a determination of expiration, extending the expiration setpoint.

12. A computer system for pricing access to e-content comprising:
tracking means for tracking one or more usage characteristics of an individual's access to e-content, wherein the one or more usage characteristics are selected from the group consisting of quantity of e-content accessed, quantity of time spent accessing the e-content, nature of the e-content, and combinations thereof; and
charging means for charging the individual a price that is determined as a predetermined function of the one or more usage characteristics.

13. The system of claim 12, further comprising:
establishing means for establishing a usage profile for the individual;
storing means for storing in the usage profile the one or more usage characteristics tracked during a first session; and
updating means for updating the usage profile to reflect the one or more usage characteristics tracked during a subsequent session.

14. The system of claim 13, wherein the updating means includes accumulating means for accumulating the one or more usage characteristics over a plurality of sessions.

15. The system of claim 14, wherein the price is determined as a predetermined function of the one or more usage characteristics of the current session, the one or more accumulated usage characteristics, or a combination thereof.

16. The system of claim 12, wherein the predetermined function is a non-linear function.

17. The system of claim 12, further comprising:
transmitting means for transmitting the e-content to a computer along with a usage tracker for tracking one or more usage characteristics; and
accepting means for accepting return of the e-content from the computer along with the one or more usage characteristics.

18. The system of claim 17, wherein the accepting means includes receiving means for receiving the entire e-content.

19. The system of claim 17, wherein the accepting means includes deleting means for deleting the e-content from the individual's computer.

20. The system of claim 17, wherein the accepting means includes determining means for determining whether any copies of the transmitted e-content were made.

21. The system of claim 12, further comprising:
transmitting means for transmitting the e-content to a computer along with a usage tracker having tracking means for tracking one or more usage characteristics; and
receiving means for receiving messages from the usage tracker indicating a change in the one or more usage characteristics.

22. A computer program product including instructions embodied on a computer readable medium, the instructions comprising:
tracking instructions for tracking one or more usage characteristics of an individual's access to e-content, wherein the one or more usage characteristics are selected from the group consisting of quantity of e-content accessed, quantity of time spent accessing the e-content, nature of the e-content, and combinations thereof; and
charging instructions for charging the individual a price that is determined as a predetermined function of the one or more usage characteristics.

23. The computer program product of claim 22, further comprising:
establishing instructions for establishing a usage profile for the individual;
storing instructions for storing in the usage profile the one or more usage characteristics tracked during a first session; and
updating instructions for updating the usage profile to reflect the one or more usage characteristics tracked during a subsequent session.

24. The computer program product of claim 23, wherein the updating instructions include accumulating instructions for accumulating the one or more usage characteristics over a plurality of sessions.

25. The computer program product of claim 24, wherein the price is determined as a predetermined function of the one or more usage characteristics of the current session, the one or more accumulated usage characteristics, or a combination thereof.

26. The computer program product of claim 22, wherein the predetermined function is a non-linear function.

27. The computer program product of claim 22, further comprising:
transmitting instructions for transmitting the e-content to a computer along with a usage tracker for tracking one or more usage characteristics; and
accepting instructions for accepting return of the e-content from the computer along with the one or more usage characteristics.

28. The computer program product of claim 27, wherein the accepting instructions include receiving instructions for receiving the entire e-content.

29. The computer program product of claim 27, wherein the accepting instructions includes deleting instructions for deleting the e-content from the individual's computer.

30. The computer program product of claim 27, wherein the accepting instructions include determining instructions for determining whether any copies of the transmitted e-content were made.

31. The computer program product of claim 22, further comprising:
transmitting instructions for transmitting the e-content to a computer along with a usage tracker having tracking instructions for tracking one or more usage characteristics; and
receiving instructions for receiving messages from the usage tracker indicating a change in the one or more usage characteristics.

32. A method for providing access to e-content on a server, comprising:
transmitting e-content from the server to a client computing device along with an embedded usage tracking program;
receiving a usage report from the usage tracking program including one or more characteristic of the client's access to the e-content;
determining whether the client's access to the e-content exceeds an expiration setpoint; and
upon a determination of expiration, initiating renewal of the e-content expiration setpoint.

33. A method for accessing e-content on a server, comprising:
requesting access to e-content on the server;
downloading e-content from the server to a client computing device along with an embedded usage tracking program;
monitoring, using the usage tracking program, one or more characteristic of the client's access to the e-content;
transmitting, using the usage tracking program, a usage report including the one or more characteristics from the client to the server; and
receiving an expiration notice from the server when access to the e-content exceeds an expiration setpoint.
